(19) United States
(12) Patent Application Publication
(10) Pub. No.: US 2014/0201342 A1
(43) Pub. Date: Jul. 17, 2014

(54) USER-FRIENDLY STORAGE NETWORK ZONING

(71) Applicant: INTERNATIONAL BUSINESS MACHINES CORPORATION, Armonk, NY (US)

(72) Inventors: David Joseph Gimpl, Rochester, MN (US); Nedzad Taljanovic, Tucson, AZ (US)

(73) Assignee: INTERNATIONAL BUSINESS MACHINES CORPORATION, Armonk, NY (US)

(21) Appl. No.: 13/739,141

(22) Filed: Jan. 11, 2013

(51) Int. Cl. G06F 15/177

(52) U.S. Cl. CPC G06F 15/177
USPC 709/221

(57) ABSTRACT

A method for configuring zoning within a switch of a storage network is disclosed. In one embodiment, such a method includes providing a list of devices to a user. The method enables the user to select devices from the list and assign the devices to a zone of a storage network. To determine which ports of a switch the devices are connected to, the method searches a device inventory database containing information about devices in the storage network. The method then determines underlying port-to-port mappings that are needed to enable communication between the devices through the switch. The method then sends a request to the switch to establish, within the switch, the zone with the determined port-to-port mappings. A corresponding apparatus and computer program product are also disclosed.

### BACKGROUND

1. Field of the Invention

This invention relates to apparatus and methods for performing zoning in storage networks such as fibre channel storage networks.

2. Background of the Invention

In storage networks, “zoning” refers to the partitioning of a switched fabric topology into smaller subsets, referred to as “zones.” A device included in a zone may communicate with other devices in the zone, but may be prevented from communicating with devices not in the zone or in other zones. Among other benefits, zoning may reduce interference between devices, improve security by preventing communication between devices in different zones, and simplify management of a storage network.

Currently, there are two main methods for performing zoning, referred to as “hard” and “soft” zoning, with each having different sets of attributes. Soft zoning works by restricting the naming service of a switched fabric, such that a device only sees the names of devices that it is authorized to communicate with. However, in soft zoning, the device can communicate with other unnamed devices if it knows their addresses. Hard zoning, by contrast, restricts actual communication between devices across the fabric, making hard zoning much more secure.

Hard zoning is implemented in most storage network switches to restrict communication between devices connected to the switch's ports. To enable communication between two devices connected to a switch's ports, a user typically must map one port, or hexadecimal port address, to another port, or hexadecimal port address. Typical user interfaces for performing this process are quite primitive. As a result, this process is not user-friendly and can become very complex and error-prone when many devices are connected to a switch. In some cases, a user may accidentally omit a port when zoning a multi-port system or incorrectly transcribe a port address.

For example, consider the case where a server needs to access a storage volume over a switch. To enable such access, communication needs to be enabled between the server and the storage subsystem hosting the storage volume. The server and storage subsystem may each have multiple associated port addresses (i.e., be connected to multiple ports of the switch). In order to enable the desired access, a user may have to log into a switch's user interface, select all relevant hexadecimal port addresses, and perform the mapping action. In current applications, it is up to the user to record hexadecimal addresses and associate them with devices when performing zoning.

In view of the foregoing, what are needed are apparatus and methods to more effectively establish zoning in storage networks. Ideally, such apparatus and methods will be more user-friendly and hide underlying complexity from a user.

### SUMMARY

The invention has been developed in response to the present state of the art and, in particular, in response to the problems and needs in the art that have not yet been fully solved by currently available apparatus and methods. Accordingly, the invention has been developed to enable users to more effectively configure zoning in a storage network. The features and advantages of the invention will become more fully apparent from the following description and appended claims, or may be learned by practice of the invention as set forth hereinafter.

Consistent with the foregoing, a method for configuring zoning within a switch of a storage network is disclosed herein. In certain embodiments, such a method includes providing a list of devices to a user. The method enables the user to select devices from the list and assign the devices to a zone of a storage network. To determine which ports of a switch the devices are connected to, the method searches a device inventory database containing information about devices in the storage network. The method then determines underlying port-to-port mappings that are needed to enable communication between the devices through the switch. The method then sends a request to the switch to establish, within the switch, the zone with the determined port-to-port mappings.

A corresponding apparatus and computer program product are also disclosed and claimed herein.

### BRIEF DESCRIPTION OF THE DRAWINGS

In order that the advantages of the invention will be readily understood, a more particular description of the invention briefly described above will be rendered by reference to specific embodiments illustrated in the appended drawings. Understanding that these drawings depict only typical embodiments of the invention and are not therefore to be considered limiting of its scope, the invention will be described and explained with additional specificity and detail through use of the accompanying drawings, in which:

FIG. 1 is a high-level block diagram showing one example of a computer network architecture for implementing an apparatus and method in accordance with the invention;

FIG. 2 is a high-level block diagram showing one example of a switch and director implemented within a storage network;

FIG. 3 is a high-level block diagram showing one example of a platform management server configured to discover and gather information about devices connected to a storage network, and a zoning module configured to utilize the data gathered by the platform management server;

FIG. 4 is a high-level block diagram showing various modules that may be included in or associated with a zoning module in accordance with the invention;

FIG. 5 is a process flow diagram showing one embodiment of a method for establishing zoning in a storage network;

FIG. 6 shows one example of a user interface associated with a zoning module in accordance with the invention; and

FIG. 7 is a process flow diagram showing one embodiment of a method for discovering devices in a zone and notifying a user about possible problems in the zone.

### DETAILED DESCRIPTION

It will be readily understood that the components of the present invention, as generally described and illustrated in the Figures herein, could be arranged and designed in a wide variety of different configurations. Thus, the following more detailed description of the embodiments of the invention, as represented in the Figures, is not intended to limit the scope of the invention, as claimed, but is merely representative of certain examples of presently contemplated embodiments in accordance with the invention. The presently described embodiments will be best understood by reference to the drawings, wherein like parts are designated by like numerals throughout.

As will be appreciated by one skilled in the art, the present invention may be embodied as an apparatus, system, method, or computer-usable medium. Furthermore, the present invention may take the form of a hardware embodiment, a software embodiment (including firmware, resident software, micro-code, etc.) configured to operate hardware, or an embodiment combining software and hardware aspects that may all generally be referred to herein as a “module” or “system.” Furthermore, the present invention may take the form of a computer-usable medium embodied in any tangible medium of expression having computer-usable program code stored therein.

Any combination of one or more computer-usable or computer-readable medium(s) may be utilized to store the computer program product. The computer-usable or computer-readable medium may be, for example but not limited to, an electronic, magnetic, optical, electromagnetic, infrared, or semiconductor system, apparatus, or device. More specific examples (a non-exhaustive list) of the computer-readable medium may include the following: a portable computer diskette, a hard disk, a random access memory (RAM), a read-only memory (ROM), an erasable programmable read-only memory (EPROM or Flash memory), a portable compact disc read-only memory (CDROM), an optical storage device, or a magnetic storage device. In the context of this document, a computer-usable or computer-readable medium may be any medium that can contain, store, or transport the program for use by or in connection with the instruction execution system, apparatus, or device.

Computer program code for carrying out operations of the present invention may be written in any combination of one or more programming languages, including an object-oriented programming language such as Java, Smalltalk, C++, or the like, and conventional procedural programming languages, such as the “C” programming language or similar programming languages. The program code may execute entirely on a user's computer, partly on a user's computer, as a stand-alone software package, partly on a user's computer and partly on a remote computer, or entirely on a remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

The present invention may be described below with reference to flowchart illustrations and/or block diagrams of methods, apparatus, systems, and computer-usable mediums according to embodiments of the invention. It will be understood that each block of the flowchart illustrations and/or block diagrams, and combinations of blocks in the flowchart illustrations and/or block diagrams, can be implemented by computer program instructions or code. These computer program instructions may be provided to a processor of a general-purpose computer, special-purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable medium that can direct a computer or other programmable data processing apparatus to function in a particular manner, such that the instructions stored in the computer-readable medium produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide processes for implementing the functions/acts specified in the flowchart and/or block diagram block or blocks.

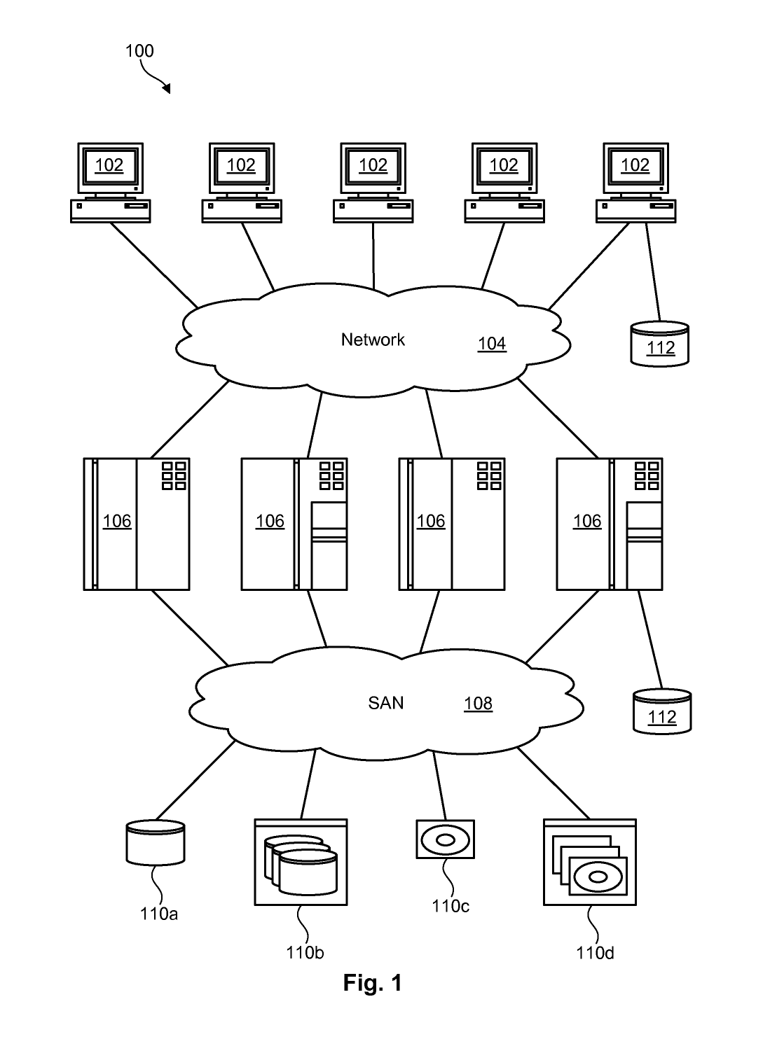

Referring to FIG. 1, one embodiment of computer-network architecture 100 is illustrated. The architecture 100 is presented to show one example of an environment where an apparatus and method in accordance with the invention may be implemented. The architecture 100 is presented only by way of example and is not intended to be limiting. Indeed, the apparatus and methods disclosed herein may be applicable to a wide variety of different network architectures, in addition to the network architecture 100 shown.

As shown, one embodiment of a computer-network architecture 100 for use with the present invention may include one or more computers 102, 106 interconnected by a network 104. The network 104 may include, for example, a local-area-network (LAN) 104, a wide-area-network (WAN) 104, the Internet 104, a Fibre Channel network 104, or the like. In certain embodiments, the computers 102, 106 may include both client computers 102 and server computers 106. In general, client computers 102 may initiate communication sessions, whereas server computers 106 may wait for requests from the client computers 102. In certain embodiments, direct-attached storage systems 112 (e.g., hard disk drives, solid state drives, etc.) may be connected directly to the computers 102 and/or servers 106. The computers 102 and servers 106 may communicate with the direct-attached storage devices 112 using protocols such as ATA, SATA, SCSI, SAS, Fibre Channel, or the like.

The computer-network architecture 100 may, in certain embodiments, include a storage network 108 behind the servers 106, such as a storage-area-network (SAN) 108 or a LAN 108 (e.g., when using network attached storage). This network 108 may connect the servers 106 to one or more storage systems 110, such as individual hard disk drives 110a or solid state drives 110a, arrays 110b of hard disk drives or solid state drives, tape drives 110c, tape libraries 110d, CD-ROM libraries, or the like. Where the network 108 is a SAN, the servers 106 and storage systems 110 may communicate using a networking standard such as Fibre Channel (FC). In certain embodiments, a Fibre Channel network 108 may use a transport protocol, such as Fibre Channel Protocol (FCP), to transport SCSI commands over the network 108.

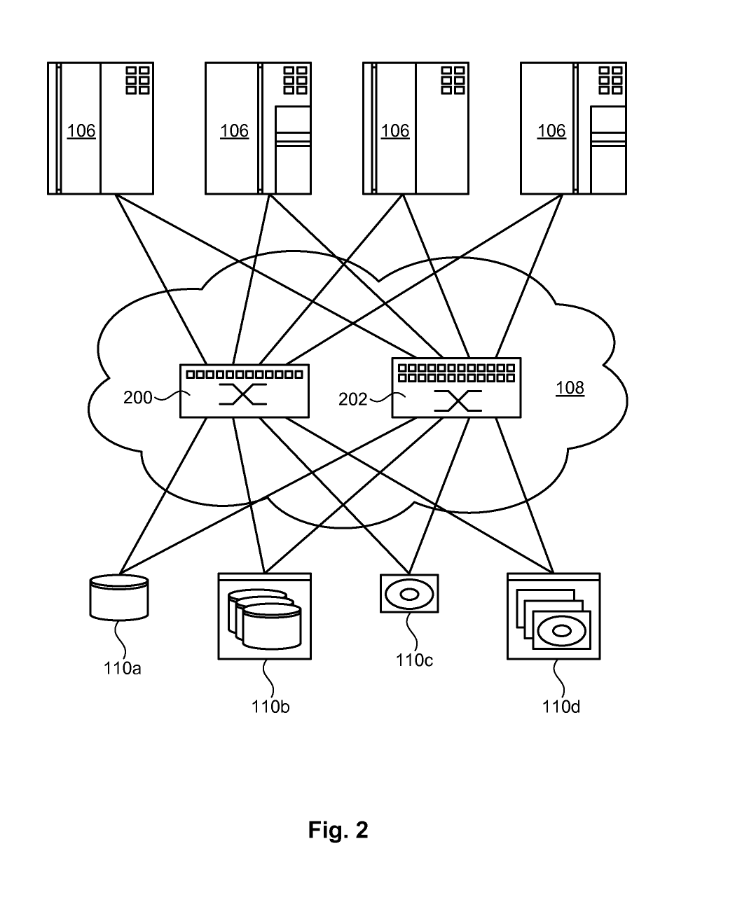

Referring to FIG. 2, in selected embodiments, a storage-area-network 108 may provide connectivity between the servers 106 and the storage systems 110 using one or more interconnect components, such as switches, directors, hubs, gateways, bridges, routers, or the like. These interconnect components may create a fabric 108 between the servers 106 and the storage systems 110. As shown in FIG. 2, a switch 200 and a director 202 may be used to provide a switched fabric 108 between the servers 106 and the storage systems 110. For the purposes of this disclosure, a switch 200 and/or director 202 will be referred to hereinafter as simply a switch 200.

As previously described, in certain embodiments, a switched fabric 108 may be partitioned into zones to reduce interference between devices, improve security, and/or simplify management of the storage network 108. Such zoning may be implemented on a storage network switch 200 to restrict communication between devices connected to the switch's ports. In prior art systems, to enable communication between two devices connected to a switch's ports, a user would need to map one port, or hexadecimal port address, to another port, or hexadecimal port address. Such systems have usability problems in that such system are difficult to set up, as well as difficult to maintain after setup.

For example, in a scenario where a server 106 needs to access a storage volume over a switch 200, communication needs to be enabled between the server 106 and the storage subsystem 110 hosting the storage volume. The server 106 and storage subsystem 110 may each connect to multiple ports of the switch 200. To enable the desired access, a user may need to log into a switch's user interface, select all relevant hexadecimal port addresses associated with the server 106 and storage subsystem 110, and perform the mapping action. To do so, the user would need to research which hexadecimal port addresses correspond to the server 106 and storage subsystem 110.

Even after a switch 200 is configured with a desired zoning configuration, the configuration can quickly become out-of-date or faulty. For example, cables may be purposely or inadvertently connected to different ports of a switch 200, thereby altering the zoning configuration. This can compromise security as well as alter other characteristics, such as redundancy. For example, moving a cable from one switch port to another may cause one of a device's ports to fall outside a zone, possibly reducing the number of redundant paths that can communicate through the zone. In more drastic cases, a device that could formerly communicate through the zone may longer be able to do so. In yet other cases, a device formerly inside the zone may have its security compromised by inadvertently enabling communication with a device outside of the zone. Because of the non-user-friendly way in which conventional systems map port addresses inside a switch, establishing and maintaining a zoning configuration can be a complex and mistake-prone process.

Thus, improved apparatus and methods are needed to establish zones in a storage network 108 as well as maintain the zones once they are established. Ideally, such apparatus and methods will be user-friendly and hide underlying complexity (i.e., the underlying port-to-port mappings) from a user. Further needed are improved apparatus and methods for discovering and presenting an existing zoning configuration to user, as well as identifying mistakes or irregularities in the existing zoning configuration. Such apparatus and methods are disclosed hereinafter.

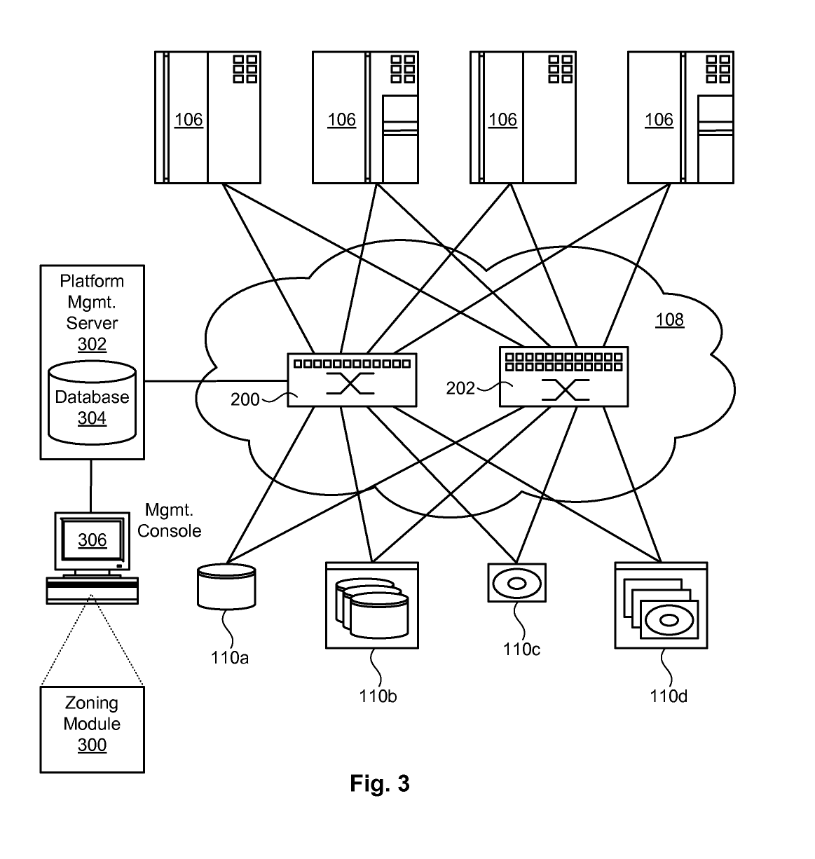

Referring to FIG. 3, in certain embodiments, a zoning module 300 in accordance with the invention may enable a user to establish and maintain a zoning configuration in a much more user-friendly way. Instead of requiring a user to identify ports and port addresses to map within a particular zone, the zoning module 300 may instead enable a user to select from a list of devices (e.g., host devices 106, storage devices 110, storage volumes, etc.) to include in a zone. The zoning module 300 may then automatically determine the port addresses associated with the selected devices that need to be mapped in the zone. Once the port-to-port mapping are determined, the zoning module 300 may generate and send a request to a switch 200, which may receive the request and establish the desired port-to-port mappings.

In order to provide the above-stated functionality, the zoning module 300 may need more information than is available in a typical switch 200. To acquire the needed information, the zoning module 300 may communicate with a platform management server 302, such as an IBM® Systems Director server 302. Among other information, the platform management server 302 may collect information regarding which ports of a switch 200 that various devices 106, 110 of a storage network 108 are connected to, and store this information in a device inventory database 304. The device inventory database 304 may be present on the platform management server 302, or on a different server.

The platform management server 302 may provide a processing engine for managing network resources. In certain embodiments, the platform management server 302 may interface with a management console 306 that provides a graphical user interface for accessing information gathered by the platform management server 302. Similarly, in order to gather desired information, the platform management server 302 may communicate with various “agents” that represent the resources 106, 110 of the storage network 108 being managed. These “agents” may include network resources 106, 110 (e.g., host systems 106, storage systems 110, storage volumes, etc.) with agent software running on them, agentless systems, and/or other network devices.

As shown in FIG. 3, in certain embodiments, the zoning module 300 is installed on the same computer system that acts as the management console 306. In other embodiments, the zoning module 300 is installed on a computing system other than that acting as the management console 306. Thus, the location of the zoning module 300, as shown in FIG. 3, is provided by way of example and not limitation.

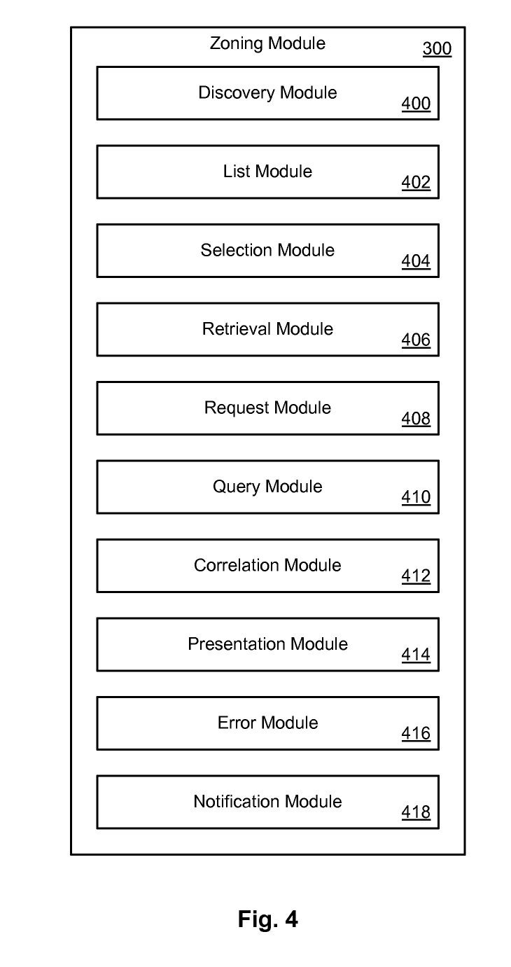

Referring to FIG. 4, in certain embodiments, the zoning module 300 discussed in association with FIG. 3 includes one or more modules to provide various features or functions. These modules may be implemented in hardware, software or firmware executable on hardware, or a combination thereof. These modules are presented by way of example and are not intended to be limiting. Indeed, alternative embodiments may include more or fewer modules than those illustrated. It should also be recognized that, in some embodiments, the functionality of some modules may be broken into multiple modules or, conversely, the functionality of several modules may be combined into a single module or fewer modules. It should also be recognized that the modules are not necessarily implemented in the locations where they are illustrated. For example, some functionality shown in the zoning module 300 may actually be implemented outside of the zoning module 300 or in a different application, such as in the platform management server 302. Other modules or functionality may be distributed across multiple computing devices. Thus, the location of the modules is presented simply by way of example and is not intended to be limiting.

As shown in FIG. 4, in selected embodiments, a zoning module 300 in accordance with the invention may include one or more of a discovery module 400, list module 402, selection module 404, retrieval module 406, request module 408, query module 410, correlation module 412, presentation module 414, error module 416, and notification module 418.

The discovery module 400 may be configured to discover resources 106, 110, such as host systems 106 and storage systems 110, connected to a storage network 108. In addition, the discovery module 400 may be configured to discover attributes associated with the resources 106, 110. For example, the discovery module 400 may be configured to discover switch ports and associated port addresses that each of the resources 106, 110 are connected to.

In certain embodiments, the discovery module 400 is embodied as a platform management server 302 that communicates with software agents installed on various network resources 106, 110. These agents may gather information on their respective resources 106, 110 and return the information to the platform management server 302 for storage in a device inventory database 304. Alternatively, or additionally, the discovery module 400 may be embodied as a platform management server 302 that gathers information from agentless network resources 106, 110 for storage in the device inventory database 304.

A list module 402 may be configured to provide a list of devices (e.g., host systems 106, storage systems 110, storage volumes, other network devices, etc.) to a user. In certain embodiments, the list of devices corresponds to those discovered by the discovery module 400. In certain embodiments, the list may include virtual devices, such as aggregates of multiple physical devices, or subdivisions of single physical devices. For example, multiple storage systems may be grouped into a storage system pool. Such a pool could be presented to a user as a single virtual device. In another example, a single physical server may host multiple virtual servers, each of which may be presented as individual devices to a user. Similarly, a single storage subsystem may host multiple storage volumes, real or virtual, each of which may be presented to a user as an individual device.

Although virtual devices may not have physical addresses, they may nevertheless be associated with ports and port addresses using relationships captured in the device inventory database 304. For example, for a storage system pool, the ports of the storage system pool may include the set of all ports of individual storage systems belonging to the pool. The ports of a virtual server may include the ports of the physical parent server on which it resides. The ports of a storage volume may include the ports of the storage subsystem on which it resides.

A selection module 404 may enable a user to select devices from the list and add them to a zone. In response to the selection, a retrieval module 406 may retrieve switch ports and port addresses for each of the selected devices from the device inventory database 304. These ports and port addresses may be used to determine the port-to-port mappings needed to enable communication between the devices through the zone. Using these ports and port addresses, a request module 408 may generate a request that may be sent to the switch 200 to produce the desired port-to-port mappings therein. In certain embodiments, all or part of the information needed by the switch 200 to produce the desired port-to-port mappings may contained in the request, or alternatively, be contained in other prior or subsequent communications with the switch 200. Using this information, the switch 200 may establish the port-to-port mappings. Establishing the port-to-port mappings may include creating a new zone that includes the port-to-port mappings, adding the port-to-port mappings to an existing zone, modifying the port-to-port mappings in an existing zone, or the like.

In certain embodiments, the zoning module 300 may also provide a more user-friendly way to determine an existing zoning configuration. For example, instead of presenting a list of mapped port addresses to a user, the zoning module 300 may present a list of actual or virtual devices included in a zone.

For example, in one embodiment, a query module 410 may query a switch 200 for existing port-to-port mappings associated with one or more zones. In response, the switch 200 may return the port port-to-port mappings. Alternatively, the query module 410 may query a device inventory database 304 for existing port-to-port mappings that have been captured by a platform management server 302 (i.e., the platform management server 302 may be configured to capture zones and port-to-port mappings when taking the inventory of a switch 200 and store this information in the device inventory database 304).

In certain embodiments, the port-to-port mappings are returned in a non-user-friendly format—e.g., mapped hexadecimal port addresses. A correlation module 412 may then correlate the returned port-to-port mappings to actual or virtual devices in the storage network 108. In certain embodiments, this is accomplished by correlating port addresses with physical or virtual devices inventoried in the device inventory database 304.

A presentation module 414 may then present, to a user, all of the physical and/or virtual devices associated with one or more zones. In certain embodiments, this may be as simple as presenting one or more lists of devices to a user, where each list contains devices associated with a particular zone. In other embodiments, a list may be displayed for a specific device that shows all the zones for which the specific device is a member. In other embodiments, one or more maps may be displayed that graphically show mapping relationships in one or more zones. Various techniques for presenting zoning information to a user are possible and within the scope of the invention.

In certain embodiments, an error module 416 may be configured to detect errors or irregularities in a zoning configuration. For example, the error module 416 may detect a situation where a device (e.g., host system 106, storage system 110, etc.) in a zone is connected to one or more switch ports that are not included in the zone. Such a situation may occur, for example, where a cable is inadvertently moved from one switch port to another, causing the device's port to fall outside the zone. This may create security issues or eliminate desired redundancy through zone. If an error or irregularity is detected, a notification module 418 may notify a user so that corrective action may be taken.

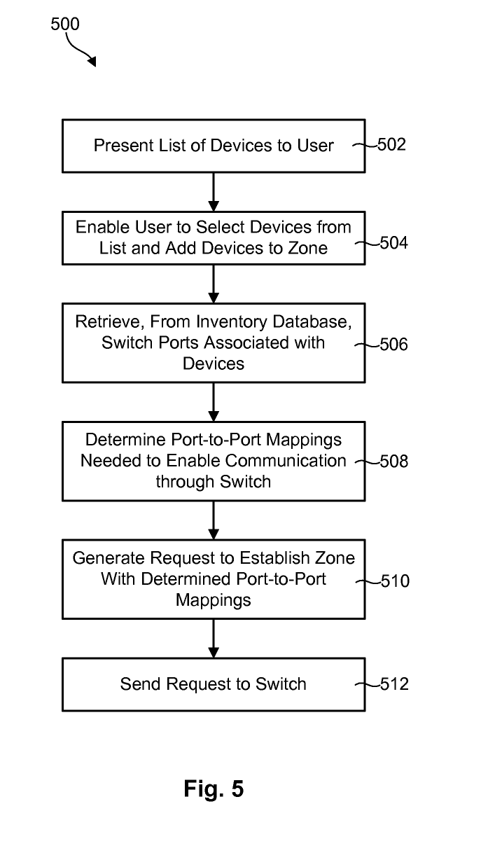

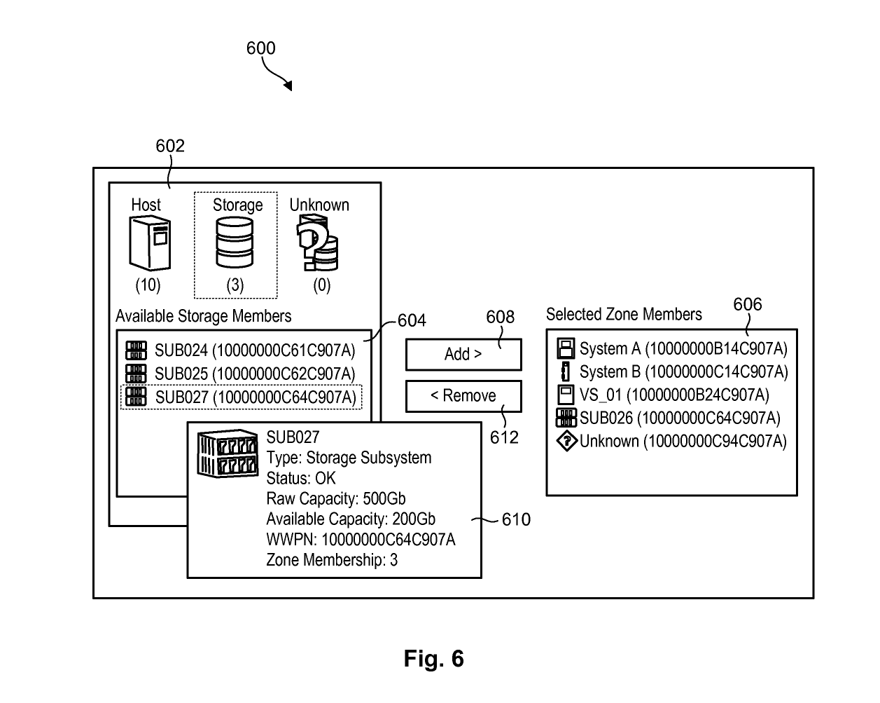

Referring to FIG. 5, one embodiment of a method 500 for establishing a zoning configuration in a storage network 108 is illustrated. As shown, the method 500 initially presents 502 a list of devices (i.e., physical and/or virtual devices) to a user. The manner in which the list is presented may vary in different embodiments. In certain embodiments, all physical and/or virtual devices are presented in a single list. In other embodiments, different types of devices may be presented in different lists. For example, a user may be presented with a list of different device types. Selecting a device type may display physical and/or virtual devices of the selected device type. One example of such a list is at least partially shown in FIG. 6.

Once a list of devices is presented 502 to the user, the user may select 504 devices from the list and add 504 the devices to a zone. Different techniques, such as dragging and dropping a device from the list, selecting from a context menu associated with a device in the list, using arrow buttons to move devices in the list, or the like, may be used add a device to a zone. One example using arrow buttons is shown in FIG. 6.

Once one or more devices have been selected, the method 500 may retrieve 506 switch ports associated with the selected devices from the device inventory database 304 and determine 508 the port-to-port mappings that are needed to enable communication through the zone. The method 500 may then generate 510 a request to establish a zone with the desired port-to-port mappings, and send 512 the request to a switch 200. Upon receiving the request, the switch 200 will establish the zone and port-to-port mappings therein, thereby enabling communication between the selected devices.

Referring to FIG. 6, one example of a graphical user interface (GUI) 600 for use with a zoning module 300 in accordance with the invention is illustrated. As shown, in the illustrated example, the GUI 600 provides a list 602 of device types, where each device type is represented by a selectable icon. In this example, the list 602 includes icons representing host devices 106, storage devices 110, as well as other network devices. In this example, selecting a device type will cause the GUI 600 to display a list 604 of network devices (physical and/or virtual) of the selected type. For example, selecting the storage device icon from the list 602 causes the GUI 600 to display “Available Storage Members,” as shown in FIG. 6. Similarly, members of a zone may be displayed in a list 606. In this example, a user may add an available storage member to the zone by selecting a storage member in the list 604 (e.g., with a mouse click, etc.) and clicking an “add” button 608. This will cause the storage member to appear in the zone list 606. Removing a device from the zone may be as simple as selecting a device in the zone list 606 and clicking a “remove” button 612.

Other features may be incorporated into the GUI 600. For example, in certain embodiments, a user may view information about a device by selecting (e.g., mousing over, clicking, etc.) a device in the list 604. In certain embodiments, this may cause a window 610 to appear with relevant information. Other possible features of the GUI 600 may include enabling a user to select from a list of zones (not shown) and, in response, displaying all zone members associated with the zone. The user may then add or remove members from the zone as desired. Other features of the GUI 600 may enable a user to create or delete zones.

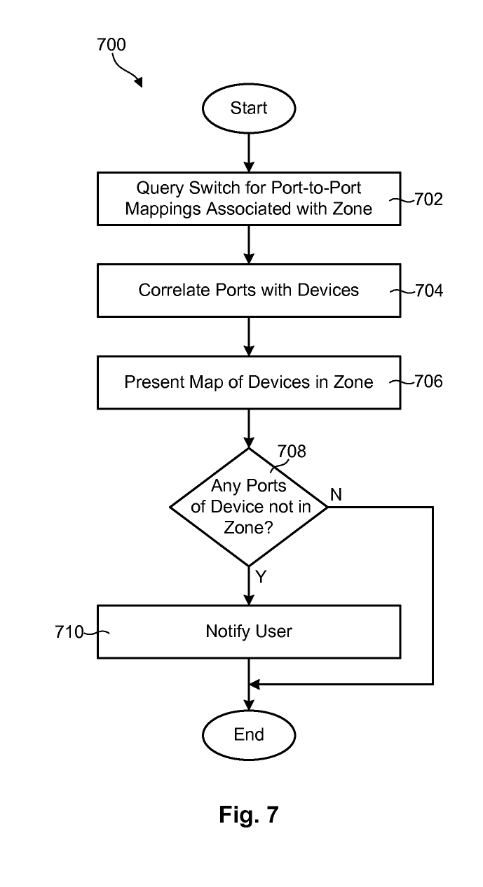

Referring to FIG. 7, one embodiment of a method 700 for discovering devices in a zone and notifying a user about possible errors or irregularities in a zone is illustrated. As shown, in order to discover the current configuration of a zone and present the configuration to a user in a user-friendly manner, the method 700 may initially query 702 a switch 200 or device inventory database 304 for port-to-port mappings associated with a zone. The method 700 may then correlate 704 the ports with devices. In certain embodiments, this may include finding devices in a device inventory database 304 associated with the ports. The method 700 may then present 706 a device map that shows the devices that are included in the zone. Such a device map may be as simple as a list of devices associated with a zone, such as the list 606 illustrated in FIG. 6.

In certain embodiments, the method 700 may be configured to look for mistakes or irregularities in a zoning configuration, thereby enabling “smarter” zoning. For example, the method 700 may determine 708 whether a device in a zone has one or more ports outside of the zone. Such a situation may occur, for example, where a cable is inadvertently moved from one switch port to another, causing one of the device's ports to fall outside the zone. As stated previously, such a situation may create security issues or eliminate desired redundancy in a zone. If an error or irregularity is detected, the method 700 may notify 710 a user so that corrective action may be taken.

The apparatus and methods disclosed herein are applicable to a wide variety of different switches 200 and switch protocols. For example, the disclosed apparatus and methods may be applicable to Fibre Channel switches, Ethernet switches, SAS switches, as well as other types of switches. Similarly, the disclosed apparatus and methods are not limited to the types of devices discussed above (i.e., host devices 106, storage devices 110, etc.) but may be applicable to all types of devices communicating through a switch 200.

The flowcharts and block diagrams in the Figures illustrate the architecture, functionality, and operation of possible implementations of systems, methods, and computer-usable media according to various embodiments of the present invention. In this regard, each block in the flowcharts or block diagrams may represent a module, segment, or portion of code, which comprises one or more executable instructions for implementing the specified logical function(s). It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustrations, and combinations of blocks in the block diagrams and/or flowchart illustrations, may be implemented by special purpose hardware-based systems that perform the specified functions or acts, or combinations of special purpose hardware and computer instructions.

1. A method for configuring zoning within a switch of a storage network, the method comprising:
providing a list of devices to a user;
enabling the user to select devices from the list and assign the devices to a zone of a storage network;
searching a device inventory database to determine which ports of a switch the devices are connected to;
determining port-to-port mappings needed to enable communication between the selected devices through the switch; and
sending a request to the switch to establish the zone with the determined port-to-port mappings.

2. The method of claim 1, further comprising querying the switch for the port-to-port mappings associated with the zone.

3. The method of claim 2, further comprising correlating the ports included in the port-to-port mappings retrieved by the query with devices in the device inventory database.

4. The method of claim 3, further comprising displaying, to a user, at least one of: devices that are configured to communicate through the zone, and all zones that are associated with a particular device.

5. The method of claim 3, further comprising determining, from the port-to-port mappings retrieved by the query, whether any devices in the zone are connected to ports that are not included in the zone.

6. The method of claim 5, further comprising notifying the user in the event one or more devices in the zone are connected to ports that are not included in the zone.

7. The method of claim 1, wherein providing a list of devices to a user further comprises providing, in the list, at least one virtual device.

8. A computer program product for configuring zoning within a switch of a storage network, the computer program product comprising a computer-readable storage medium having computer-usable program code embodied therein, the computer-usable program code comprising:
computer-usable program code to provide a list of devices to a user;
computer-usable program code to enable the user to select devices from the list and assign the devices to a zone of a storage network;
computer-usable program code to search a device inventory database to determine which ports of a switch the devices are connected to;
computer-usable program code to determine port-to-port mappings needed to enable communication between the devices through the switch; and
computer-usable program code to send a request to the switch to establish the zone with the determined port-to-port mappings.

9. The computer program product of claim 8, further comprising computer-usable program code to query the switch for the port-to-port mappings associated with the zone.

10. The computer program product of claim 9, further comprising computer-usable program code to correlate the ports included in the port-to-port mappings retrieved by the query with devices in the device inventory database.

11. The computer program product of claim 10, further comprising computer-usable program code to display, to a user, at least one of: devices that are configured to communicate through the zone, and all zones that are associated with a particular device.

12. The computer program product of claim 10, further comprising computer-usable program code to determine, from the port-to-port mappings retrieved by the query, whether any devices in the zone are connected to ports that are not included in the zone.

13. The computer program product of claim 12, further comprising computer-usable program code to notify the user in the event one or more devices in the zone are connected to ports that are not included in the zone.

14. The computer program product of claim 8, wherein providing a list of devices to a user further comprises providing, in the list, at least one virtual device.

15. An apparatus for configuring zoning within a switch of a storage network, the apparatus comprising:
at least one processor;
at least one memory device coupled to the at least one processor and storing computer instructions for execution on the at least one processor, the computer instructions causing the at least one processor to:
provide a list of devices to a user;
enable the user to select devices from the list and assign the devices to a zone of a storage network;
search a device inventory database to determine which ports of a switch the devices are connected to;
determine port-to-port mappings needed to enable communication between the devices through the switch; and
send a request to the switch to establish the zone with the determined port-to-port mappings.

16. The apparatus of claim 15, wherein the computer instructions further cause the at least one processor to query the switch for the port-to-port mappings associated with the zone.

17. The apparatus of claim 16, wherein the computer instructions further cause the at least one processor to correlate the ports included in the port-to-port mappings retrieved by the query with devices in the device inventory database.

18. The apparatus of claim 17, wherein the computer instructions further cause the at least one processor to display, to a user, at least one of: devices that are configured to communicate through the zone, and all zones that are associated with a particular device.

19. The apparatus of claim 17, wherein the computer instructions further cause the at least one processor to determine, from the port-to-port mappings retrieved by the query, whether any devices in the zone are connected to ports that are not included in the zone.

20. The apparatus of claim 19, wherein the computer instructions further cause the at least one processor to notify the user in the event one or more devices in the zone are connected to ports that are not included in the zone.

21. The apparatus of claim 15, wherein the computer instructions further cause the at least one processor to provide, in the list, at least one virtual device.
